(19) United States
(12) Patent Application Publication
(10) Pub. No.: US 2011/0217525 A1
(43) Pub. Date: Sep. 8, 2011

(54) FLEXIBLE SOLID FIRE-RESISTANT COATING, METHOD FOR APPLYING A FIRE-RESISTANT COATING A SUBSTRATE, AND SUBSTRATE PROVIDED WITH SUCH A COATING

(75) Inventor: Gerrit Janus Vos, Eethen (NL)

(73) Assignee: Altena Services B.V., Waalwijk (NL)

(21) Appl. No.: 12/674,207

(22) PCT Filed: Aug. 20, 2008
(86) PCT No.: PCT/NL2008/050558

§ 371 Date: May 19, 2010

(30) Foreign Application Priority Data
Aug. 20, 2007 (NL) 200822
Dec. 4, 2007 (NL) 2001052

(51) Int. Cl. B32B 7/02; B32B 37/02; B32B 37/12; B32B 37/14; C09D 5/18; B29C 41/42

(52) U.S. Cl. 428/212; 156/60; 156/249; 106/15.05; 264/334

(57) ABSTRACT

Method for applying a fire-resistant coating to a substrate, comprising of applying a layer of liquid fire-resistant coating to a carrier, creating a layer of flexible solid coating as a result of at least partial curing of the layer of liquid coating, removing the layer of flexible solid coating from the carrier; and applying the flexible solid coating layer to the substrate.

The present invention relates to a flexible solid fire-resistant coating, a method for manufacturing such a coating, a method for applying a fire-resistant coating to a substrate, and a substrate provided with such a coating.

Fire resistant coatings are per se known and are generally applied to the substrate in liquid form, usually by spraying. There are however various drawbacks associated with such known coatings and the methods for application thereof. Firstly, the liquid coating can only be applied under determined conditions; when the substrate is in the open air the coating can only be applied when the air humidity allows. In addition, the degree and speed of curing depend on the temperature and air humidity. The location of an object to be provided with the coating can also be such that it is not possible to apply the coating by means of spraying, for instance because the object for treating is built in such that a sprayer cannot be placed at the required distance therefrom, or because it is not permitted to spray a coating in the vicinity of the object for treating because of risk of damage to surrounding objects by the coating or solvents thereof.

A further drawback is that generally no operation can be carried out on the substrate while the liquid coating cures, since the still liquid coating could be damaged here, for instance because it reacts with a subsequent (lacquer) layer to be applied. It may also be that, for employee health reasons, no work may be carried out in the space around the substrate due to the solvents released during curing of the liquid coating.

The invention therefore has for its object to provide a flexible solid fire-resistant coating, a method for applying a fire-resistant coating to a substrate, and a substrate provided with such a coating, wherein at least the above stated drawbacks are obviated.

The invention provides for this purpose a method as according to claim 1 and/or 11, a coating as according to claim 12 and a substrate as according to claim 15.

For an improved adhesion—particularly when the adhesion of the coating has decreased during the curing—an adhesive is preferably applied to the substrate before applying of the flexible solid coating layer to the substrate. The composition of the adhesive preferably substantially corresponds here to the composition of the same fire-resistant coating in liquid form (wherein the coating is in fact provided with a solvent), wherein the side, applied to the liquid coating, of the at least partially cured, and thus applied together with the coating applied in liquid form, flexible hard coating partially dissolves due to the presence of the liquid coating, in order to thus form an even better and uniform coating. This is because after curing of the adhesive the adhesive and the coating have a substantially homogeneous composition.

The pre-applied coating, also referred to as primer, can here also be provided with a colour in order to provide a better coverage of a subsequent layer or to create a contrast with the substrate in order to ensure a uniform and complete application of the primer during application thereof.

A preferred embodiment of the method for applying a fire-resistant coating to a substrate according to the present invention comprises of applying a layer of liquid fire-resistant coating to a carrier, creating a layer of flexible solid coating as a result of at least partial curing of the layer of liquid coating, removing the layer of flexible solid coating from the carrier and applying the flexible solid coating layer to the substrate.

Because the coating has at least partially cured at the moment it is applied to the substrate, it is less sensitive, or even insensitive, to the temperature and humidity during but mainly directly after the application, whereby application can take place under more conditions than in the prior art method of application. It is noted here that the curing according to the invention can take place under controlled conditions. The temperature, air humidity and dust suppression can be particularly well controlled.

Owing to the at least partially cured coating a subsequent treatment, such as application of a subsequent lacquer layer, can also take place more quickly. In addition, people working in the vicinity of the substrate provided with the coating are not exposed to (a large quantity of) solvents.

In the present application at least partial curing is understood to mean the following. When applied, the coating used preferably has a ratio of 65% to 70% solid and 35% to 30% softening agent or solvent, or water. This ratio can be achieved in that the coating is supplied in this manner by a manufacturer, although the method according to the present invention can however comprise of diluting or dissolving the liquid coating until this ratio is obtained. A coating has cured when the softening agent, the solvent or the water has been reduced to a proportion of between 10% and 20%, and in particular when it is about 15%.

A particularly uniform coating layer can be applied to the carrier when application of the layer of liquid fire-resistant coating to the carrier is performed by means of spraying, vapour-deposition or painting, wherein the painting preferably takes place using a roller. Particularly good results are obtained when the layer is applied by means of pouring (optionally in combination with skimming to the desired thickness). Because application of the coating to the carrier can take place under controlled conditions, for instance in a workshop adapted or intended for this purpose, much less loss and waste of coating occurs here, whereby less coating is required for the purpose of coating a determined surface.

Depending on the desired or required degree or duration of fire resistance, the layer can have a thickness between 0.1 mm and 5 mm. Thicknesses of 0.5 mm, 1 mm, 1.5 mm, 2 mm, 2.5 mm, 3 mm, 3.5 mm, 4 mm and 4.5 mm are particularly applied. These thicknesses can be chosen subject to current regulations or the substrate used, or subject to a desirable or permitted method of applying the coating. This coating can thus be provided in the form of a wallpaper or in the form of a film.

When strict requirements are set for the surface smoothness of the coating in order to obtain better possibilities of adhesion to a substrate or for a top layer to be applied at a later time, or for aesthetic reasons, a glass plate can be chosen as the carrier. However, the carrier preferably comprises a flexible material, such as cardboard or aluminium foil, so that the coating, once it has cured, can be easily removed from the carrier. The use of an aluminium (foil) carrier provides the further advantage that the thickness of the applied layer can be determined very accurately using measuring means on the basis of reflection. It is even possible in this way to produce a coating varying in thickness over its surface, wherein a degree of stretching during application of the coating to the intended substrate is taken into account by applying a thicker coating layer at locations where a greater stretching can be anticipated, for instance due to the presence of a sharp corner or a bulge in the substrate.

It is on the other hand also possible to provide the carrier with a determined relief in order to obtain a coating with a predetermined surface structure, which can itself have a decorative function and thus renders unnecessary the application of a decorative layer with a structure.

The coating can further be provided with a dye, for instance with a RAL colour, so as to eliminate the necessity of applying one or more lacquer layers after application of the coating to the substrate, or to make applying of a final lacquer layer easier in that the coating has a colour which either corresponds with the colour of the lacquer layer still to be applied, or forms a basis therefor which can be readily overpainted.

The carrier is preferably provided with a top layer of material to which the coating has a poor adhesion, at least after partial or full curing, such that the coating can be removed after the at least partial curing. A plastic layer is in many cases—depending on the coating used—suitable for this purpose. It will be apparent that the cardboard or aluminium foil provided with this plastic layer is preferably also still flexible in order to enable easy removal of the coating from the layer.

In order to simplify transport or storage of the coating, the coating can be brought into a state suitable for transport or storage, such as a roll or a strip, together with the carrier or after removal of the layer of flexible solid coating from the carrier. It is particularly advantageous when the dimensions of such a strip correspond substantially with dimensions of the substrate to which it is intended to apply the coating. The dimensions can thus corresponds with those of a door, wall, pillar or glass plate to be coated, whereby applying of the coating can also take place in considerably less time.

In order to prevent adhesion of the coating to itself during or after rolling up of the coating, the coating can be provided on at least one side with a protective foil. This protective foil can be arranged especially before the coating is rolled up or form part of the carrier of the coating, which in that case is not removed before the coating is rolled up. It is also possible for the carrier to be already provided with a foil before the coating is applied, this foil having the property that it can be removed from the carrier together with the coating after at least partial curing of the coating. A second object of this protective layer is to seal the coating from oxygen in order to ensure that the coating remains flexible during storage and transport. This is because the coating dries out when it comes into contact with oxygen, thereby making its application to a substrate more difficult.

A further advantage can be achieved by irradiating the coating with infrared light after application to the substrate in order to improve the drying of the coating and adhesion of the coating to the substrate. Temperatures of 70 to 90 degrees Celsius are optimal here, at least in the cases where the substrate can withstand such temperatures.

Because the outside of the flexible solid coating does not dissolve, the advantages, such as being able to apply and more rapidly process the at least partially cured coating under more conditions, are preserved.

In addition, the applying of the coating can be carried out by less skilled personnel, and the coating can even take place in simple manner on already placed or built-in or treated substrates where the use of a liquid coating is undesirable or impossible.

The substrate to which the coating can be applied is for instance a metal, wood, a ceramic material, glass, plastic or stone, or concrete, while the coating can comprise a variety of protective layers.

Depending on the material and/or the form of the substrate, the desired or allowable drying time and the desired or allowable flexibility, the coating can optionally be provided with a quantity of solvent.

A composition for the coating which has been found particularly suitable is Interchar 404 ENV12281 fireproofing, marketed by Akzo Nobel, or a coating of similar composition. HCA topcoat exterior or a coating of similar composition can be applied as top layer. In this way a foil can be manufactured which is both flexible and strong, so that it does not break or tear when applied, and can in addition be readily applied to a variety of surfaces.

The invention will now be elucidated with reference to the following figures, in which:

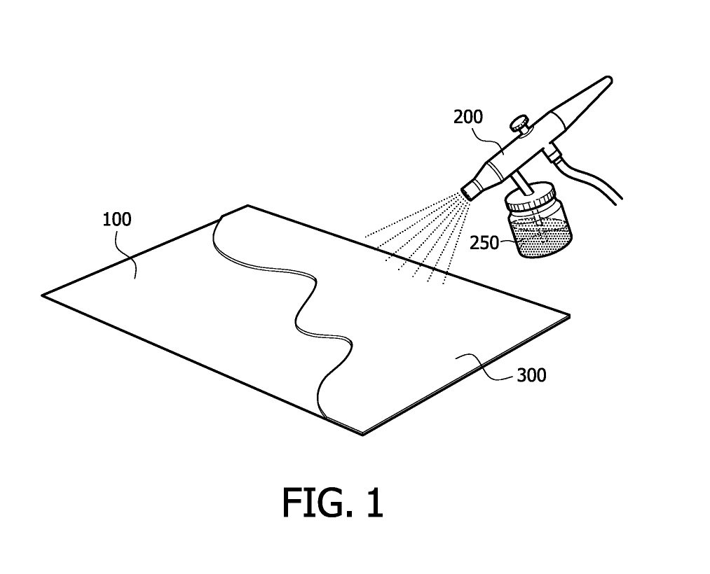

FIG. 1 shows a first step of the method according to the present invention;

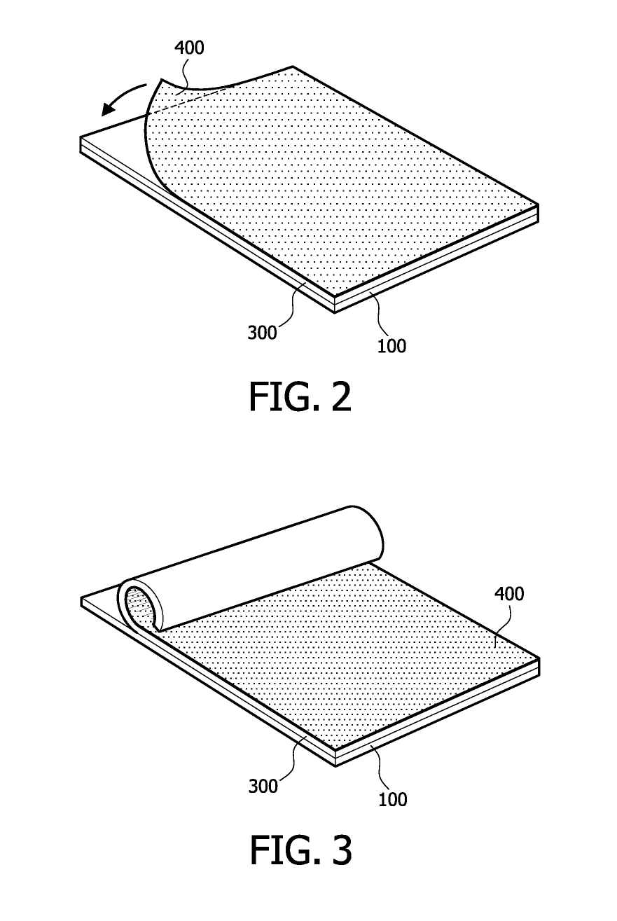

FIG. 2 shows a second step of the method according to the present invention;

FIG. 3 shows a third step of the method according to the present invention;

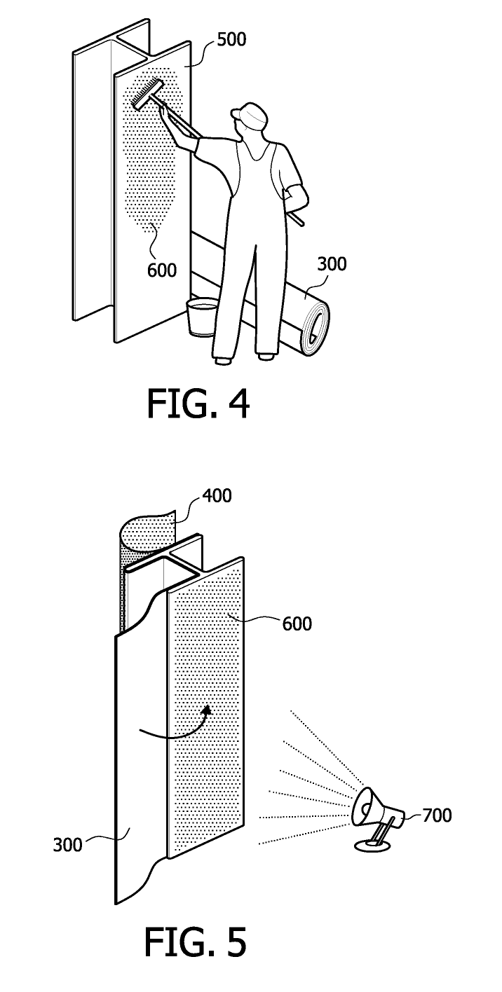

FIG. 4 shows a fourth step of the method according to the present invention; and

FIG. 5 shows a fifth step of the method according to the present invention.

FIG. 1 shows a first step of the method according to the present invention, wherein a coating layer 300 is applied to a carrier 100 using a paint sprayer 200 provided with a reservoir with liquid coating 250. The treatment shown in FIG. 1 preferably takes place in a ventilated space adapted for this purpose.

FIG. 2 shows carrier 100 provided with coating layer 300, on which a foil 400 is arranged. The foil can be arranged immediately after coating layer 300 has been applied to carrier 100, whereby evaporation of solvents from the coating, and thereby drying of the coating, is counteracted, or can be arranged after a time so that coating layer 300 has cured a little more.

FIG. 3 shows the formation of a roll of at least partially cured coating layer 300 and foil 400, wherein the foil ensures that coating 300 does not adhere to itself when it is rolled up.

FIG. 4 shows a substrate 500 formed by an H-profile being provided with an adhesive 600 before application of coating 300, wherein adhesive 600 is preferably the same as liquid coating 250 of FIG. 1.

FIG. 5 shows the application of coating 300 to substrate 500, wherein foil 400 is removed. After applying of coating 300 the adhesion of coating 300 to substrate 500 can be accelerated by activating infrared lamp 700.

1. Method for applying a solid fire-resistant coating to a substrate, comprising of:
applying an adhesive to the substrate, wherein the adhesive comprises a layer of the same fire-resistant coating in liquid form; and
applying the flexible solid coating layer to the substrate.

2. Method as claimed in claim 1, comprising of manufacturing the solid coating layer by means of:
applying a layer of liquid fire-resistant coating to a carrier,
creating a layer of flexible solid coating as a result of at least partial curing of the layer of liquid coating,
removing the layer of flexible solid coating from the carrier.

3. Method as claimed in claim 1, wherein the substrate comprises a metal, wood, a ceramic material, glass, plastic, concrete or stone.

4. Method as claimed in claim 1, wherein the layer has a thickness between 0.1 mm and 5 mm.

5. Method as claimed in claim 2, wherein the carrier comprises a flexible material, such as cardboard or aluminum foil.

6. Method as claimed in claim 5, wherein the carrier is provided with a top layer of a material to which the coating has a poor adhesion such that the coating can be removed after at least partial curing, such as plastic layer.

7. Method as claimed in claim 2, further comprising of:
bringing the layer of flexible solid coating into a state suitable for transport, such as a roll or a strip, after removal of the layer of flexible solid coating from the carrier.

8. Method as claimed in claim 7, wherein dimensions of the strip correspond substantially with dimensions of the substrate.

9. Method as claimed in claim 1, further comprising of:
applying an adhesive to the substrate before applying the flexible solid coating layer to the substrate.

10. Method as claimed in claim 9, wherein the adhesive comprises a layer of the same fire-resistant coating in liquid form.

11. Method for applying a fire-resistant coating to a substrate, particularly as claimed in claim 1, comprising of:
applying a layer of liquid fire-resistant coating to a carrier, wherein the application of the layer of liquid fire-resisting coating to the carrier is performed by means of pouring;
creating a layer of flexible solid coating as a result of at least partial curing of the layer of liquid coating;
removing the layer of flexible solid coating from the carrier; and
applying the flexible solid coating layer to the substrate.

12. Flexible solid fire-resistant coating, comprising a layer of at least partially cured liquid fire-resistant coating.

13. Flexible solid fire-resistant coating as claimed in claim 12, brought into a state suitable for transport, such as a roll or a strip.

14. Flexible solid coating, manufactured by:
applying a layer of liquid fire-resistant coating to a carrier;
creating a layer of flexible solid coating as a result of at least partial curing of the layer of liquid coating;
removing the layer of flexible solid coating from the carrier.

15. Substrate provided with a coating as claimed in claim 14.

16. Substrate as claimed in claim 15, wherein the coating is adhered to the substrate by means of an adhesive, wherein the composition of the adhesive substantially corresponds to the composition of the coating.

17. Substrate as claimed in claim 16, wherein the adhesive and the coating are substantially fully integrated with each other at least after curing of the adhesive.
